(19) United States
(12) Patent Application Publication
(10) Pub. No.: US 2006/0037426 A1
(43) Pub. Date: Feb. 23, 2006

(54) Motion transmitting remote control with conduit connection verification

(76) Inventor: William G. Teller, Lake Orion, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/922,460

(22) Filed: Aug. 20, 2004

(51) Int. Cl. F16C 1/10; G05G 1/14

(52) U.S. Cl. 74/512

(57) ABSTRACT

An adjustable pedal assembly includes a screw (62) for moving a pedal (16) along a rod (22) between a plurality of adjusted positions. A conduit (53) rotatably supports a core element (55) that is rotated by an electrical motor (52). A pair of female (56) and male (57) connectors attach the conduit (53) in an operative position on a gearbox (20) with the core element (55) connected to a worm (58) engaging a worm gear (60) to rotate the screw (62). Any such adjustable pedal assembly may be characterized by a pair of electrical contacts (70) and (72) supported by the respective connectors (56) and (57) for electrical contact to transmit electrical current through the electrical leads (74) and (76) when the connectors (56) and (57) are connected together but for discontinuing electrical conductivity when the connectors (56) and (57) are separated. The drive motor (52) is operative only when the connectors (56) and (57) snugly interconnected.

### BACKGROUND OF THE INVENTION

1. Field of the Invention

The subject invention relates to an adjustable pedal assembly of the type for adjusting the operative position of the accelerator and brake pedals of an automotive vehicle. More specifically, the invention relates a motion transmitting remote control assembly of the type having a flexible core element movably supported in a conduit for transmitting motion in a curved path and used in the mechanical drive mechanism for adjusting the operative position of the pedal.

2. Description of the Related Art

The use of motion transmitting cable assemblies to transmit motion by a flexible core element for adjusting or moving components in an automotive vehicle is well known. Besides adjustable pedals, such motion transmitters are used to adjust seats, air conditioning systems, and the like. The core element is often driven by an electric motor and is supported in a conduit having connectors for attaching the conduit with the core element in driving engagement with a device. However, for various reasons, the conduit connector can become disconnected so that motion is not transmitted when the drive motor is energized. This can a problem in adjustable pedal systems having a plurality of pedals that must be adjusted in unison.

### BRIEF SUMMARY OF THE INVENTION AND ADVANTAGES

The invention resides in a motion transmitting remote control assembly for transmitting motion in a curved path and comprising a conduit having first and second ends and a flexible motion transmitting core element movably disposed in the conduit and extending between the ends. A connector is disposed at one first end of the conduit for attaching the conduit in an operative position with the core element connected to a motion-transmitting device. The assembly is characterized by an electrical contact supported by the connector for electrical engagement with a contact in the operative position and an electrical lead extending from the contact for establishing electrical continuity when the connector is connected in the operative position and for breaking such electrical continuity when disconnected from the operative position.

In accordance with the subject invention, an electrically driven core element supported in a conduit can not be driven by an electric motor unless the conduit is securely connected with the core element in driving connection with the proper device.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a fragmentary perspective view of an adjustable pedal assembly;

FIG. 2 is an exploded perspective view of the pedal assembly of FIG. 1;

FIG. 3 is a cross sectional view taken along line 3-3 of FIG. 1;

FIG. 4 is a cross sectional view taken along line 4-4 of FIG. 1;

FIG. 5 is a bottom view of the gearbox and guide rod of the assembly;

FIG. 6 is a bottom view of the nut of the assembly;

FIG. 7 is a cross sectional view of the bottom of the hub of the assembly; and

FIG. 8 is a cross sectional view taken along line 8-8 of FIG. 1.

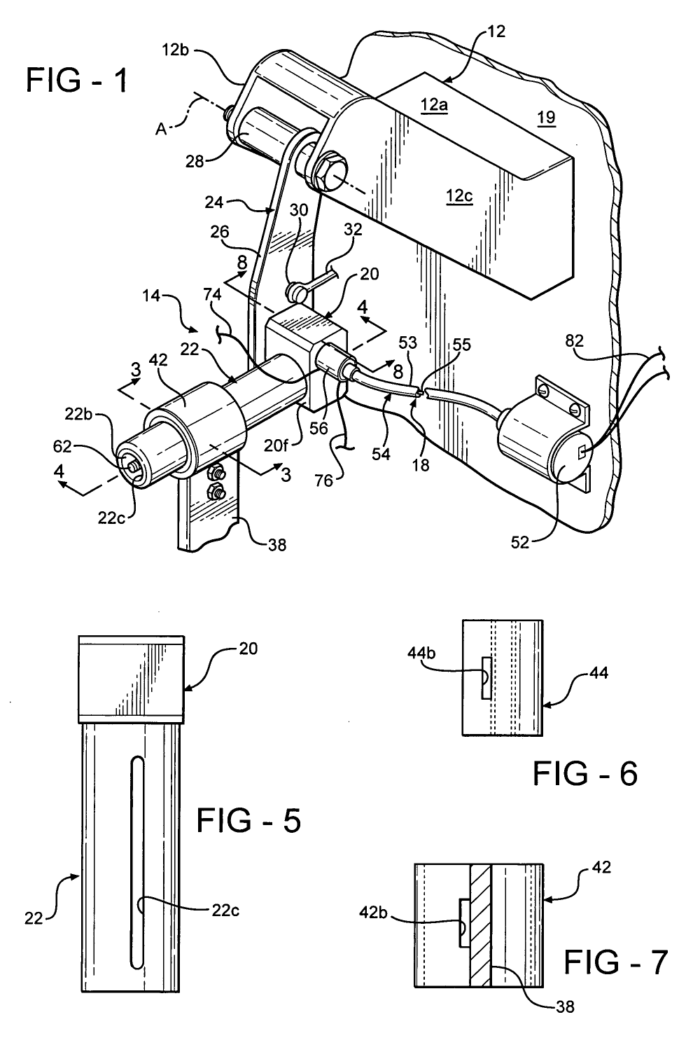

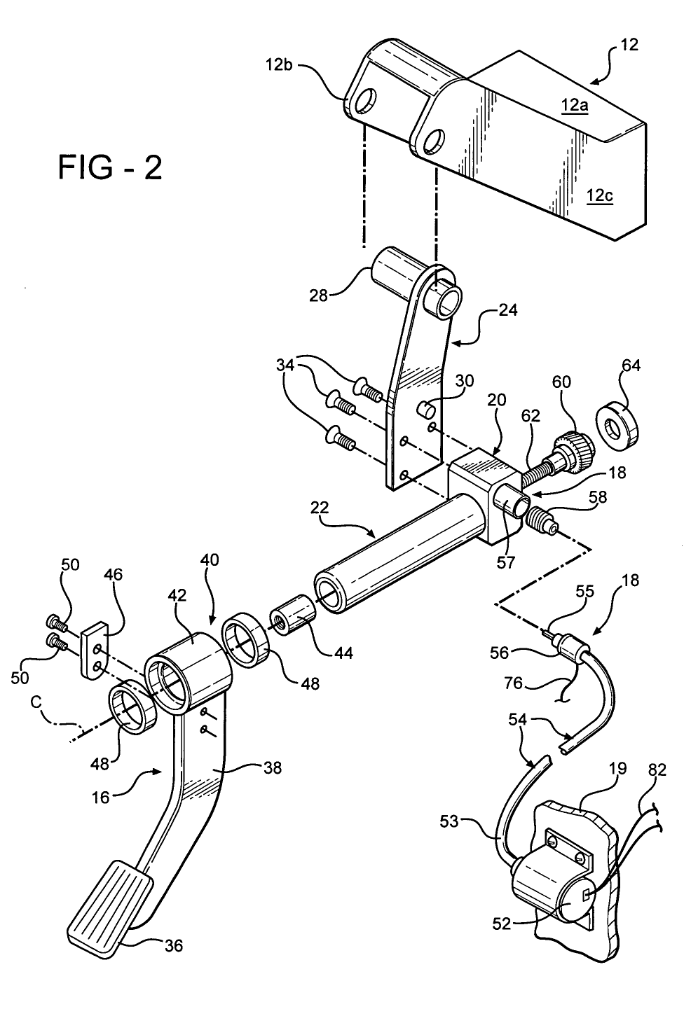

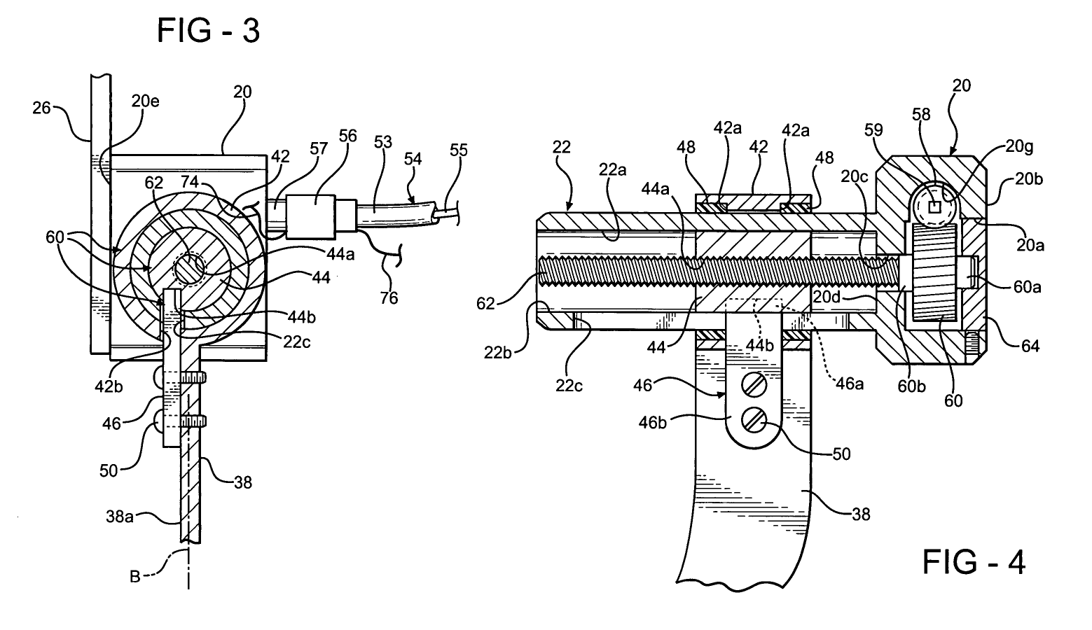

### DETAILED DESCRIPTION OF THE INVENTION

Referring to the Figures, wherein like numerals indicate like parts throughout the several views, an adjustable pedal assembly is shown as comprising a mounting structure or bracket 12 for attachment to a vehicle structure, a pedal support or adjustment device 14 for moving a pedal 16 between a plurality of adjusted positions relative to the mounting structure 12, the pedal 16 being pivotally supported for rotational movement about a pivot axis (A) relative to the mounting structure 12.

A drive mechanism 18 is included for moving the adjustment device 14 between the plurality of adjusted positions.

The mounting bracket 12 may be formed of any suitable sheet metal material in a suitable stamping operation and is intended for attachment to the firewall 19 of the associated motor vehicle. As illustrated, the bracket 12 includes a top wall 12a and laterally spaced side walls 12b and 12c.

The pedal support or adjustment sub-assembly 14 includes transmission housing or gear-box 20, a circular and hollow guide rod 22, and an adjustment arm 24. The gear-box 20 and the guide rod 22 may be formed as separate items or as a single forged piece, as shown. The gear-box or transmission housing 20 has a generally cubical configuration and defines a hollow 20a opening at the front face 20b of the housing 20 and a central bore 20c defined in a rear wall 20d of the housing. The guide rod 22 extends rigidly rearwardly from the rear wall 20d of the transmission housing 20 and is hollow to provide a tubular configuration defining a central bore 22a concentric with bore 20c. The guide rod 22 is open at its rear end 22b, and includes a bottom axial slot 22c extending from a location proximate transmission wall 20d to a location proximate rod rear end 22b. The slot 22c is offset relative to the central vertical axis or plane (B) that contains the axis (C) of adjustment or the guide rod.

The adjustment arm 24 includes an elongated plate 26, a pivot pin 28 fixedly secured to the upper end of the plate 26 and pivotally mounted to the rear end of bracket 12 in bracket side walls 12b and 12c. The pivot pin 28 defines the pivot axis (A) about which the adjustment arm 24 rotates during normal operation of the pedal assembly. During such normal operation, the pedal plate 26 moves a control rod 32 to operate a throttle or brake of an automotive vehicle. A control pin 30 is secured to the plate 26 and pivotally receives one end of the control rod 32. The lower end of the plate 26 is secured, as by fasteners 34, to a side face 20e of the gear-box or transmission housing 20.

The pedal 16 is a sub-assembly including a pedal pad 36, a pedal arm 38 carrying the pedal pad 36 at its lower end, and an upper guide structure 40. The upper guide structure 40 includes a hub 42, a nut 44 and a key 46. The hub 42 is fixedly secured to or integral with the upper end of pedal arm 38 and has a circular internal diameter to be slidably mounted on guide rod 22 with the aid of bushings 48 positioned in suitable annular recesses 42a proximate the forward and rearward annular edges of the hub 42. The hub 42 and bushings 48 define a smooth guide bore slidably receiving the guide rod 22 thereby supporting the pedal 16 to move smoothly axially forwardly and rearwardly with respect to the guide rod, i.e., rectilinearly or in a straight line.

A nut 44, which may be formed of plastic, has a circular cross-sectional configuration, and is sized to fit slidably within the bore 22a of the guide rod 22, and includes a threaded central bore 44a.

A key 46 is in the configuration of an elongated plate and is secured at its upper end 46a in a keyway 44b provided in the lower face of nut 44 in offset relationship to the central vertical axis (B) of the apparatus. The key 46 passes downwardly through the elongated axial slot 22c in the lower side or bottom of the guide rod 22 and through an aperture 42b in the hub structure 42 for attachment by fasteners 50 at its lower end 46b to a side face 38a of the pedal arm 38.

The drive mechanism 18 includes an electrically energized drive motor 52, a cable or motion transmitting remote control assembly 54, and the gearbox 20. The gearbox 20 rotatably supports a worm 58, a worm wheel 60, and a screw shaft 62. The electric motor 52 comprises a small electric motor of known form and may be secured, for example, to firewall 19 by a clamp or bracket. The motion transmitting assembly 54 includes a conduit 53 having first and second ends and a flexible motion transmitting core element 55 movably, i.e., rotatably, disposed in the conduit 53 and extending between and from the ends of the conduit 53. A coupling, comprising female 56 and male 57 connectors, is disposed at the first end of the conduit 53 for attaching the conduit 53 in an operative position with the core element 55 connected to a motion transmitting device, i.e., the gearbox 20. More specifically, the core element 55 is rotated by the output shaft of the electric motor 52 and engages the square drive opening 59 in the end of the worm 58 for rotating the worm 58. The worm 58 is journalled in a cross bore 20g in the gearbox 20 in overlying relation to the gearbox cavity 20a. The worm 58 is in driving engagement with worm wheel or gear 60 positioned in the cavity 20a of the housing 20. The worm gear 60 includes a front trunion 60a journalled in a bushing 64 fixedly positioned in the open forward end of the cavity 20a and a rear trunion 60b journalled in a counterbore 20g of the bore 20c.

The drive mechanism 18 also includes a screw or threaded shaft 62 extending rearwardly from the worm wheel or gear 60 and through the guide rod bore 20a for threaded engagement with the threaded central bore 44a of the nut 44. Accordingly, rotation of the screw 62 has the effect of sliding the nut 44 forwardly and rearwardly within the bore 22a of the hollow guide rod 22. The screw 62 and the nut 44 move the nut 44 along the screw 62 in response to rotation of the screw 62 by the core element 55, the gear box 20 operatively or drivingly interconnecting the core element 55 and the screw 62.

In operation, the position of the pedal 36 relative to the operator is selectively adjusted by selectively energizing the motor 52 to selectively move the nut 44 rectilinearly along the screw 62 within guide rod bore 22a and thereby, via the key 46, move the pedal 16 forwardly and rearwardly along the guide rod 22 with the limits of forward and rearward movement determined by engagement of the key with the respective forward and rearward ends of the slot 22c.

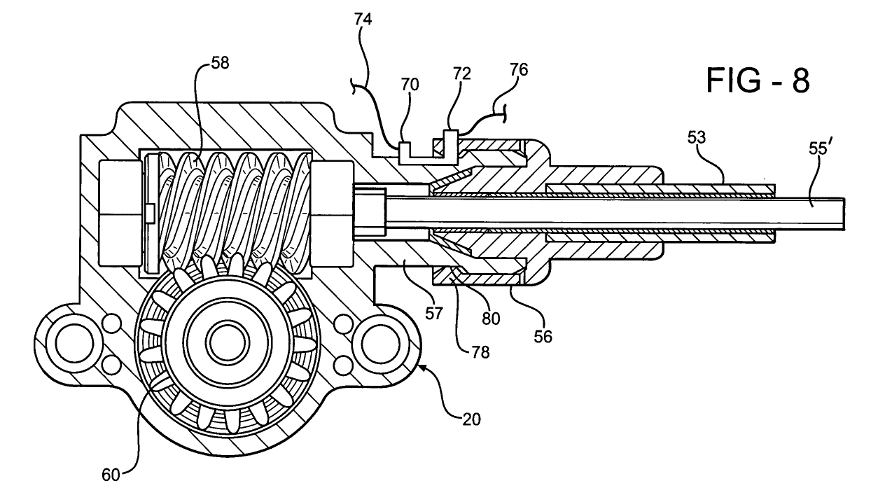

The adjustable pedal assembly is characterized by a pair of electrical contacts 70 and 72 (FIG. 8) supported by the respective connectors 56 and 57 of the coupling for electrical engagement with one another in the operative or interconnected position. An electrical lead 74 and 76 extends from each of the contacts 70 and 72 for establishing electrical continuity when the coupling is in the operative position and for breaking such electrical continuity when disconnected from the operative position. In other words, the contacts 70 and 72 are in electrical contact to transmit electrical current through the electrical leads 74 and 76 when the connectors 56 and 57 of the coupling are connected together and when the connectors 56 and 57 are separated the slightest amount, the electrical contact is lost and electrical conductivity through the electrical leads 74 and 76 is lost. The electrically energized drive motor 52 is responsive to the electrical leads 74 and 76 for allowing operation of the drive motor 52 only when the coupling is in the operative position with the connectors 56 and 57 snugly interconnected. The connectors 56 and 57 are connectable and separable with each supporting one of the contacts 70 or 72 for electrical engagement when the connectors 56 and 57 are connected together in the operative position. The female connector 56 is typically molded of plastic on the end of the conduit 53 and includes an expandable collet 78 for snapping into an annular groove 80 in the male connector 57.

As is well know, a power supply 82 supplies electrical power to the electrical motor 52 and the contacts 70, 72 are in series with the power supply 82 for discontinuing power to the electrical motor 52 when the connectors 56, 57 are separated.

Accordingly, the invention provides assurances that the drive mechanism is in an operative condition before the adjustment mechanism can be energized.

Although the invention has been described in an adjustable pedal assembly utilizing rectilinear adjust via a guide rod of the type disclosed in U.S. Pat. No. 5,632,183, it is equally useful in adjustable pedal assemblies employing a parallel linkage type of adjustment as shown in U.S. Pat. No. 6,173,625; a swinging arm type of adjustment as shown in U.S. Pat. No. 6,151,984; or a pad adjustment as shown in U.S. Pat. Nos. 6,209,417 and 6,212,970. In other words, the placement of the electrical power supply to a drive motor in series with the mechanical connection of the drive mechanism driven by the motor may be used with the drive mechanism for adjusting any adjustable pedal assembly, regardless of the type of mechanical adjustment utilized.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. In addition, the reference numerals in the claims are merely for convenience and are not to be read in any way as limiting.

What is claimed is:

1. An adjustable pedal assembly comprising:
a mounting structure for attachment to a vehicle structure;
a pedal pivotally supported for rotational movement about a pivot axis relative to said mounting structure;
an adjustment device for moving said pedal between a plurality of adjusted positions relative to said mounting structure; and
a drive mechanism for moving said adjustment device between said plurality of adjusted positions;
said drive mechanism including a conduit having first and second ends, a flexible motion transmitting core element movably disposed in said conduit and extending between said ends, and
a coupling disposed at said first end of said conduit for attaching said conduit in an operative position with said core element connected to a motion transmitting device,
said assembly characterized by a pair of electrical contacts supported by said coupling for electrical engagement with one another in the operative position and an electrical lead extending from said contacts for establishing electrical continuity when said coupling is in the operative position and for breaking such electrical continuity when disconnected from the operative position.

2. An assembly as set forth in claim 1 wherein said drive mechanism includes an electrically energized drive motor in driving engagement with said core element for rotating said core element and responsive to said electrical lead for allowing operation of said drive motor only when said coupling is in the operative position.

3. An assembly as set forth in claim 2 wherein said coupling includes a pair of connectors connectable and separable with each supporting one of said contacts for electrical engagement when said connectors are connected together in said operative position.

4. An assembly as set forth in claim 3 wherein said drive mechanism includes a screw and a nut for moving said nut along said screw in response to rotation of said screw by said core element.

5. An assembly as set forth in claim 4 wherein said drive mechanism includes a gear box interconnecting said core element and said screw.

6. An assembly as set forth in claim 3 including a power supply for said electrical motor, said contacts being in series with said power supply for discontinuing power to said electrical motor when said connectors are separated.

7. A motion transmitting remote control assembly for transmitting motion in a curved path and comprising;
a conduit having first and second ends,
a flexible motion transmitting core element movably disposed in said conduit and extending between said ends,
a connector disposed at said first end of said conduit for attaching said conduit in an operative position with said core element connected to a motion transmitting device,
said assembly characterized by an electrical contact supported by said connector for electrical engagement with a contact in the operative position and an electrical lead extending from said contact for establishing electrical continuity when said connector is connected in the operative position and for breaking such electrical continuity when disconnected from the operative position.
